(19) United States
(12) Patent Application Publication
(10) Pub. No.: US 2008/0082226 A1
(43) Pub. Date: Apr. 3, 2008

(54) METHOD FOR IMPROVING VEHICULAR COMFORT AND PROTECTING INTERIOR INTEGRITY

(76) Inventors: Erick Simon Amador, Miramar, FL (US); Kulvir Singh Bhogal, Fort Worth, TX (US); Rick Allen Hamilton, Charlottesville, VA (US); Alexandre Polozoff, Bloomington, IL (US)

Correspondence Address: IBM CORP (YA);C/O YEE & ASSOCIATES PC, P.O. BOX 802333, DALLAS, TX, 75380, US

(21) Appl. No.: 11/533,104

(22) Filed: Sep. 19, 2006

(51) Int. Cl. G01M 17/00

(52) U.S. Cl. 701/29

(57) ABSTRACT

A computer implemented method, data processing system, and computer usable program code are provided for automatically initiating a set of vehicle functions for a vehicle. A set of settings is received for a set of vehicle functions. The set of settings includes a set of thresholds for the set of vehicle functions. A set of sensors are monitored on the vehicle and a signal is received from a sensor within the set of sensors indicating that a condition has occurred. Responsive to receiving the signal, a determination is made as to whether the condition meets or exceeds a threshold within the set of thresholds. Responsive to the condition meeting or exceeding the threshold, a command is sent to a device actuator to automatically perform a function within the set of vehicle functions.

### BACKGROUND OF THE INVENTION

1. Field of the Invention

The present invention relates generally to vehicle device control. More particularly, the present invention relates to a computer implemented method, data processing system, and computer usable program code for improving vehicular comfort and protecting a vehicle's interior integrity.

2. Description of the Related Art

Today's global environment, with constantly changing weather patterns, presents the world with new requirements for understanding and anticipating these changes. Being aware of how daily weather impacts a driver's daily life is now vitally important, specifically interaction with the driver's typical means for commuting, such as vehicles. For instance, prior to beginning a commute, a quick weather check will identify whether the driver puts the convertible top down or leaves the convertible top up.

Given these dynamics, it would be advantageous to have an automotive system that accounts for environmental conditions in real-time and that increases the functionality and convenience of daily vehicle interactions.

### SUMMARY OF THE INVENTION

The different aspects of the illustrative embodiments provide a computer implemented method, apparatus, and computer usable program code for automatically initiating a set of vehicle functions for a vehicle. The illustrative embodiments receive a set of settings for a set of vehicle functions. The set of settings includes a set of thresholds for the set of vehicle functions. The illustrative embodiments monitor a set of sensors on the vehicle. The illustrative embodiments receive a signal from a sensor within the set of sensors that a condition has occurred. The illustrative embodiments determine if the condition meets or exceeds a threshold within the set of thresholds in response to receiving the signal. The illustrative embodiments send a command to a device actuator to automatically perform a function within the set of vehicle functions in response to the condition meeting or exceeding the threshold.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 shows a block diagram of a data processing system in which illustrative embodiments may be implemented;

FIG. 3 depicts a functional block diagram of a vehicle comfort and protection system in accordance with an illustrative embodiment;

FIG. 4 illustrates a flowchart of the operation performed by a vehicle comfort and protection system using a plurality of sensors in accordance with an illustrative embodiment;

FIG. 5 illustrates a flowchart of the operation performed by a vehicle comfort and protection system using internet information in accordance with an illustrative embodiment;

FIG. 6 illustrates a flowchart of the operation performed by a vehicle comfort and protection system using driver's programming in accordance with an illustrative embodiment; and

FIG. 7 illustrates a flowchart of the operation performed by a vehicle comfort and protection system using received wireless commands in accordance with an illustrative embodiment.

### DETAILED DESCRIPTION OF THE PREFERRED EMBODIMENT

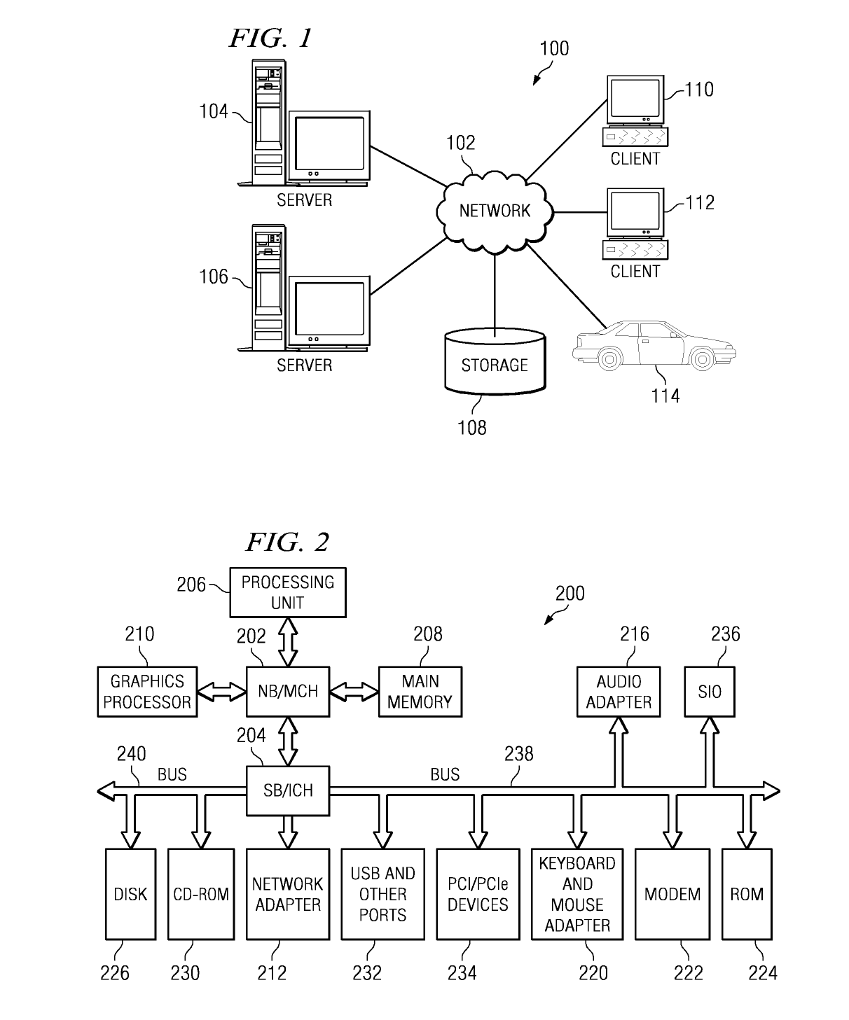

The illustrative embodiments provide for improving vehicular comfort and protecting a vehicle's interior integrity. With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110 and 112 as well as data processing system within vehicle 114 connect to network 102. Clients 110 and 112 may be, for example, personal computers or network computers. Vehicle 114 may have a data processing system that acts in a similar manner to clients 110 and 112. In the depicted example, server 104 provides data, such as configuration files and applications to clients 110 and 112 and vehicle 114. Clients 110 and 112, and vehicle 114 are clients to server 104 in this example. Network data processing system 100 may include additional servers, clients, vehicles, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104, client 110, or vehicle 114 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adaptor 212 is coupled to south bridge and I/O controller hub 204 and audio adaptor 216, keyboard and mouse adaptor 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adaptors, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adaptor. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide multiple means of enhancing the comfort and protecting the interior of a vehicle. The illustrative embodiments provide a variety of features including:
autonomous detection of surrounding environmental conditions and providing an appropriate reaction to such conditions;
autonomous vehicle communications with a Web service, with or without GPS usage, so that the vehicle may make autonomous decisions about necessary actions;
pre-programmed automation of vehicle devices; and
allowing drivers to communicate electronically with the vehicle, so as to manually issue protective actions.

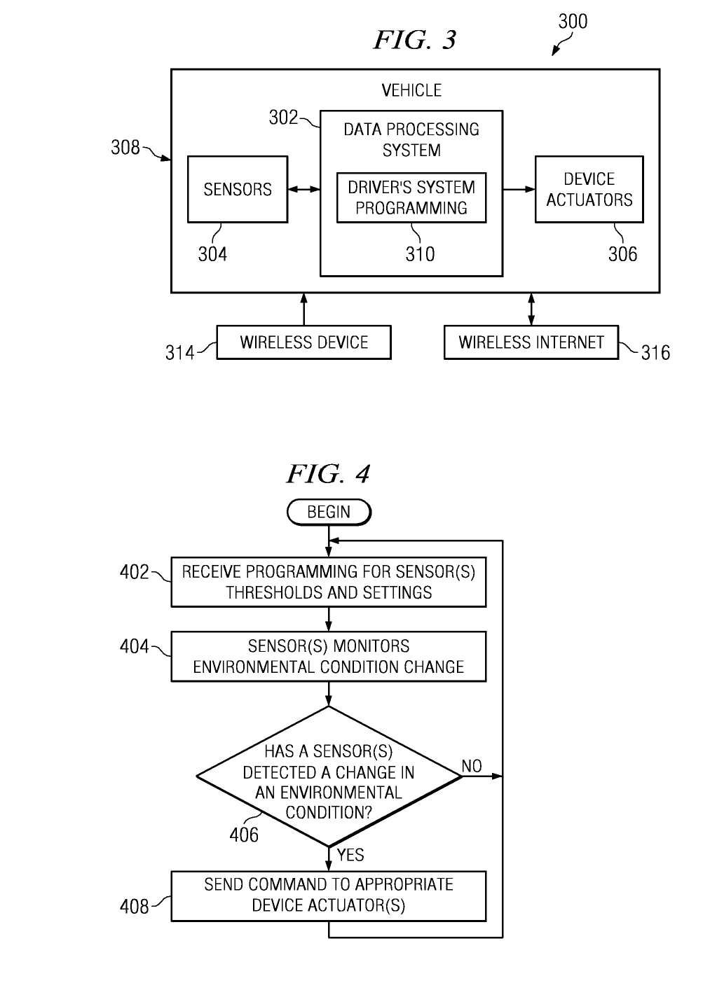

FIG. 3 depicts a functional block diagram of a vehicle comfort and protection system in accordance with an illustrative embodiment. Vehicle comfort and protection system 300 may be comprised of data processing system 302, a plurality of sensors 304, and a plurality of device actuators 306. Data processing system 302 may be a data processing system, such as data processing system 200 within FIG. 2. Data processing system 302 and device actuators 304 are located within vehicle 308. Vehicle 308 may also have a plurality of sensors 304. Sensors 304 may include precipitation sensors, internal and external temperature sensors, audio sensors, motion sensors, wireless input sensors, Internet weather information sensors, and timing sensors, although any type of sensor may be used.

In one illustrative embodiment, one or more of sensors 304 may detect a change in an environmental condition, such as precipitation or temperature. Sensor 304 then sends a signal to data processing system 302 which checks driver's system programming 310 and sends an appropriate signal to one or more of device actuators 306 to perform a set of functions. The set of vehicle functions may be one or more functions. Driver's system programming 310 may be programming that is stored on a memory, such as memory 208 of FIG. 2. In one illustrative example, precipitation is detected based on the automobile's current state. In response to this state, a convertible top may be closed or lowered windows may be raised. As an additional example, if a high temperature is detected, either internal or external to vehicle 308, then perhaps a sun shade may be deployed or raised windows may be lowered. Once the requested function is performed by the appropriate ones of device actuators 306, then vehicle comfort and protection system 300 would return to a monitoring mode to detect any future environmental changes.

In another illustrative embodiment while the ignition is off and the vehicle comfort and protection system 300 engaged, one or more of sensors 304 may detect an audio signal or motion within vehicle 308. The audio signal may be as a baby crying and the motion may be a child playing in a car and possibly locking the doors and not knowing how to unlock the doors. In response, sensors 304 then send a signal to data processing system 302. Data processing system 302 checks driver's system programming 310 and sends an appropriate signal to one or more of device actuators 306 to perform a function. In the illustrative examples, the function may be honking the horn, unlocking the doors, and/or lowering a raised window. Once the requested function is performed by the appropriate ones of device actuators 306, then vehicle comfort and protection system 300 would return to a monitoring mode to detect any future environmental changes.

In another illustrative embodiment, data processing system 302 uses driver's system programming 310 to identify a city and a state within which the vehicle is operated. Data processing system 302 may initiate a request to collect environmental data from the Internet using wireless Internet 316 using the city and state information. Data processing system 302 may request weather information from weather Websites, such as weather.com or weatherbug.com. Information from the weather Websites may identify environmental conditions such as precipitation or external temperature and this information may be sent to sensors 304 and data processing system 302. Data processing system 302 uses a signal from sensors 304 to analyze the received weather information and, along with driver's system programming 310, to determine if an action should be performed. If an action is required, data processing system sends an appropriate signal to one or more of device actuators 306 to perform a function. As an example, if the weather Website indicates that a precipitation change is pending, then a convertible top may be closed or lowered windows may be raised. As an additional example, if the weather Website indicates an external temperature that exceeds a temperature preset by the driver's system programming, then perhaps a sun shade could be deployed or raised windows lowered. Once the requested function is performed by the appropriate ones of device actuators 306, then vehicle comfort and protection system 300 would return to a monitoring mode to detect any future environmental changes.

In an additional illustrative embodiment, data processing system 302 uses a global positioning system (GPS) to determine the location that the vehicle is being operated. Data processing system 302 may initiate a request to collect environmental data from the Internet using wireless Internet 312 using the global positioning system location information. Data processing system 302 may request weather information from weather Websites, such as weather.com or weatherbug.com. Information from the weather Websites may identify environmental conditions such as precipitation or temperature and this information may be sent to sensors 304 and data processing system 302. Data processing system 302 uses a signal from sensors 304 to analyze the received weather information, along with driver's system programming 310, to determine if an action should be performed. If an action is required, data processing system sends an appropriate signal to one or more of device actuators 306 to perform a function. As an example, if the weather Website indicates that a precipitation change is pending, then a convertible top may be closed or lowered windows may be raised. As an additional example, if the weather Website indicates an external temperature that exceeds a temperature preset in driver's system programming 310, then perhaps a sun shade could be deployed or raised windows lowered. Once the requested function is performed by the appropriate ones of device actuators 306, then vehicle comfort and protection system 300 would return to a monitoring mode to detect any future environmental changes.

In another illustrative embodiment, data processing system 302 may use driver's system programming 310 to initiate changes within vehicle 308. As an example, if a driver leaves work at a specific time everyday, the driver may program vehicle 308 to lower the windows at a certain time so that the car may cool off. Times programmed by the driver may signal a timing sensor within sensors 304 which in turn signals data processing system 302 to perform a function. Data processing system 302 uses the signal from sensors 304 and the programmed information to send an appropriate signal to one or more device actuators 306 to perform a function if appropriate. Once the requested function is performed by the appropriate device actuator 306, then vehicle comfort and protection system 300 would return to a monitoring mode to detect any future environmental changes.

In an additional illustrative embodiment, data processing system 302 may receive a command from the driver via wireless device 314 to perform a specific function, which is received by a wireless signal sensor in sensors 304 and data processing system 302. Data processing system 302 uses the signal from sensors 304 and the received command information to send an appropriate signal to one or more of device actuators 306 to perform a function if appropriate. As an example, the command may be to close a convertible top or to raise lowered windows. Once the requested function is performed by the appropriate ones of device actuators 306, then vehicle comfort and protection system 300 would return to a monitoring mode to detect any future environmental changes.

FIG. 4 illustrates a flowchart of the operation performed by a vehicle comfort and protection system using a plurality of sensors in accordance with an illustrative embodiment. The sensors may be sensors, such as sensors 310 of FIG. 3.

As the operation begins, a driver programs the vehicle comfort and protection system with thresholds such as a maximum temperature and which sensors the driver would like activated (step 402). Once the driver completes programming and activates the system, the sensors monitor for a change in environmental conditions (step 404). Environmental changes may be changes such as precipitation, increased internal or external temperature, a baby crying, or motion within the car. If a sensor detects a change, the sensor sends a signal to the data processing system. The data processing system uses the signal information along with the driver's system programming to determine if a change in an environmental condition has been met (step 406). If an environmental change condition has not been met, the operation returns to step 402. If an environmental change condition has been met, then the data processing system sends a command to the appropriate device actuators so that a function will be performed (step 408), with the operation then returning to step 402 to continue monitoring for any new environmental changes. Exemplary actions performed by the device actuators may be to raise or lower a convertible top, raise or lower windows, honk a horn, lock or unlock doors, or flash lights.

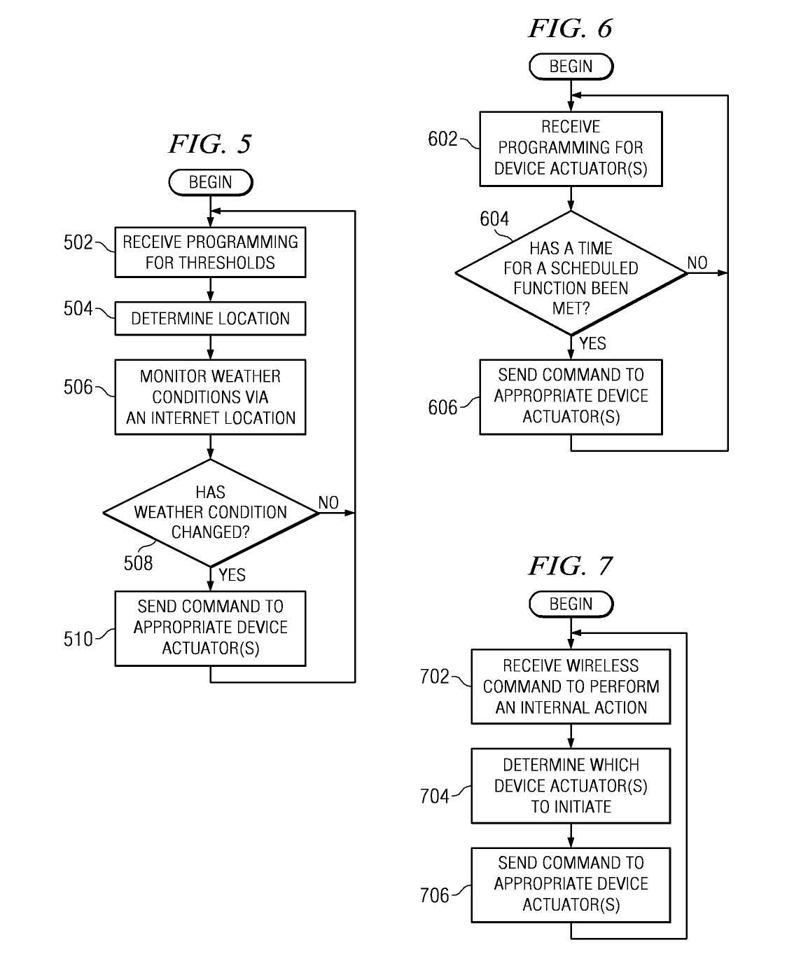

FIG. 5 illustrates a flowchart of the operation performed by a vehicle comfort and protection system using internet information in accordance with an illustrative embodiment. The Internet information may be gathered using a Wireless internet, such as wireless Internet 312 of FIG. 3.

As the operation begins, a driver programs the vehicle comfort and protection system with thresholds such as a maximum temperature and which sensors the driver would like activated (step 502). Once the driver completes programming and activates the system, the data processing system then determines the location of the vehicle (step 504). The data processing system may determine the location either through an input that was programmed by the driver or through the use of a global positioning system that provides the location of the vehicle. The data processing system then monitors the weather conditions by accessing an Internet Website and retrieving local weather conditions (step 506). Environmental changes may be changes such as pending precipitation or temperature. A sensor detects the received weather information and alerts the data processing system, which uses the weather information and the driver's system programming to determine if a change in an environmental condition has been met (step 508). If an environmental change condition has not been met, the operation returns to step 502. If an environmental change condition has been met, then the data processing system sends a command to the appropriate device actuators so that a function will be performed (step 510), with the operation then returning to step 502 to continue monitoring for any new environmental changes. Exemplary actions performed by the device actuators may be to raise or lower a convertible top or raise or lower windows.

FIG. 6 illustrates a flowchart of the operation performed by a vehicle comfort and protection system using driver's programming in accordance with an illustrative embodiment. The driver's programming may be driver's system programming, such as drivers system programming 310 of FIG. 3.

As the operation begins, a driver programs the vehicle comfort and protection system with any functions the driver would like executed at a specific time (step 602). The driver's system programming signals a sensor, which in turn signals the data processing system to determine if a time for a scheduled function has been met (step 604). Upon receiving the signal, the data processing system uses the driver's system programming information to determine the specific function that should be executed. If the time for a scheduled function has not been met, the operation returns to step 602. If a time for a scheduled function has been met, then the data processing system sends a command to the appropriate device actuators so that a function will be performed (step 606), with the operation returning to step 602 to continue monitoring for time-based events. Exemplary actions performed by the device actuators may be to raise or lower a convertible top or raise or lower windows.

FIG. 7 illustrates a flowchart of the operation performed by a vehicle comfort and protection system using received wireless commands in accordance with an illustrative embodiment. The wireless commands may be received from a wireless device, such as wireless device 316 of FIG. 3.

As the operation begins, the data processing system and sensors receive a wireless signal from a wireless device that indicates an internal action that the data processing system should initiate (step 702). Upon signaling from the wireless sensor, the data processing systems disseminates the command and determines which device actuators should be initiated (step 704). Then the data processing system sends a command to the appropriate device actuators so that a function will be performed (step 706), with the operation returning to step 702 to await further wireless communications. Exemplary actions performed by the device actuators may be to raise or lower a convertible top, raise or lower windows, honk a horn, lock or unlock doors, or flash lights.

Thus, the illustrative embodiments receive a set of settings for a set of vehicle functions and the set of settings includes a set of thresholds for the set of vehicle functions. The illustrative embodiments monitor a set of sensors on the vehicle and receive a signal from a sensor within the set of sensors that a condition has occurred. The illustrative embodiments determine if the condition meets or exceeds a threshold within the set of thresholds in response to receiving the signal. Responsive to the condition meeting or exceeding the threshold, the illustrative embodiments send a command to a device actuator to automatically perform a function within the set of vehicle functions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of automatically initiating a set of vehicle functions for a vehicle, the computer implemented method comprising:
receiving a set of settings for a set of vehicle functions, wherein the set of settings includes a set of thresholds for the set of vehicle functions;
monitoring a set of sensors that sends signals to the vehicle;
receiving a signal from a sensor within the set of sensors that a condition has occurred;
responsive to receiving the signal, determining if the condition meets or exceeds a threshold within the set of thresholds; and
responsive to the condition meeting or exceeding the threshold, sending a command to a device actuator to automatically perform a function within the set of vehicle functions.

2. The computer implemented method of claim 1, wherein the sensor is at least one of a precipitation sensor, a temperature sensor, an audio sensor, a motion sensor, a wireless input sensor, an Internet weather information sensor, or timing sensor.

3. The computer implemented method of claim 1, wherein the condition is from an external Website that provides weather conditions and further comprises:
receiving the signal from the sensor that a weather condition exists;
responsive to receiving the weather condition that is associated with a setting within the set of settings, determining if the weather condition meets or exceeds a threshold within the set of thresholds; and
responsive to the weather condition meeting or exceeding the threshold, sending the command to the device actuator to automatically perform the function within the set of vehicle functions.

4. The computer implemented method of claim 3, wherein the weather condition is determined based on a location for the vehicle and wherein the location is determined by at least one of a driver's input or by a global positioning system.

5. The computer implemented method of claim 1, wherein the function is at least one of raising a convertible top, lowering the convertible top, raising a window, lowering the window, honking a horn, flashing headlights, unlocking a door, locking the door, raising a sunshade, and lowering the sunshade.

6. The computer implemented method of claim 1, wherein the condition is from a timer that specifies when the function should occur and further comprises:
receiving the condition that a time has been met that the specific function should be initiated; and
responsive to receiving the indication, sending the command to the device actuator to automatically perform the specific function within the set of vehicle functions.

7. The computer implemented method of claim 1, wherein the sensor is a wireless device sensor that indicates a function to be performed and further comprises:
receiving the signal from the wireless device to perform a specific function;
responsive to receiving the signal, sending the command to the device actuator to automatically perform the specific function within the set of vehicle functions.

8. A data processing system comprising:
a bus system;
a communications system connected to the bus system;
a memory connected to the bus system, wherein the memory includes a set of instructions; and
a processing unit connected to the bus system, wherein the processing unit executes the set of instructions to receive a set of setting for a set of vehicle functions, wherein the set of settings includes a set of thresholds for the set of vehicle functions; monitors a set of sensors that sends signals to the vehicle; receives a signal from a sensor within the set of sensors that a condition has occurred; determines if the condition meets or exceeds a threshold within the set of thresholds in response to receiving the signal; and sends a command to a device actuator to automatically perform a function within the set of vehicle functions in response to the condition meeting or exceeding the threshold.

9. The data processing system of claim 8, wherein the sensor is at least one of a precipitation sensor, a temperature sensor, an audio sensor, a motion sensor, a wireless input sensor, an Internet weather information sensor, or timing sensor.

10. The data processing system of claim 8, wherein the condition is from an external Website that provides weather conditions and wherein the processing unit executes the set of instructions to receive the signal from the sensor that a weather condition exists; determines if the weather condition meets or exceeds a threshold within the set of thresholds in response to receiving the weather condition that is associated with a setting within the set of settings; and sends the command to the device actuator to automatically perform the function within the set of vehicle functions in response to the weather condition meeting or exceeding the threshold.

11. The data processing system of claim 10, wherein the weather condition is determined based on a location for the vehicle and wherein the location is determined by at least one of a driver's input or by a global positioning system.

12. The data processing system of claim 8, wherein the condition is from a timer that specifies when the function should occur and wherein the processing unit executes the set of instructions to receive the condition that a time has been met that the specific function should be initiated; and sends the command to the device actuator to automatically perform the specific function within the set of vehicle functions in response to receiving the indication.

13. The data processing system of claim 8, wherein the sensor is a wireless device sensor that indicates a function to be performed and wherein the processing unit executes the set of instructions to receive the signal from the wireless device to perform a specific function; sends the command to the device actuator to automatically perform the specific function within the set of vehicle functions in response to receiving the signal.

14. A computer program product comprising:
a computer usable medium including computer usable program code for automatically initiating a set of vehicle functions for a vehicle, the computer program product including:
computer usable program code for receiving a set of settings for a set of vehicle functions, wherein the set of settings includes a set of thresholds for the set of vehicle functions;
computer usable program code for monitoring a set of sensors that sends signals to the vehicle;
computer usable program code for receiving a signal from a sensor within the set of sensors that a condition has occurred;
computer usable program code for determining if the condition meets or exceeds a threshold within the set of thresholds in response to receiving the signal; and
computer usable program code for sending a command to a device actuator to automatically perform a function within the set of vehicle functions in response to the condition meeting or exceeding the threshold.

15. The computer program product of claim 14, wherein the sensor is at least one of a precipitation sensor, a temperature sensor, an audio sensor, a motion sensor, a wireless input sensor, an Internet weather information sensor, or a timing sensor.

16. The computer program product of claim 14, wherein the condition is from an external Website that provides weather conditions and further includes:
computer usable program code for receiving the signal from the sensor that a weather condition exists;
computer usable program code for determining if the weather condition meets or exceeds a threshold within the set of thresholds in response to receiving the weather condition that is associated with a setting within the set of setting; and
computer usable program code for sending the command to the device actuator to automatically perform the function within the set of vehicle functions in response to the weather condition meeting or exceeding the threshold.

17. The computer program product of claim 16, wherein the weather condition is determined based on a location for the vehicle and wherein the location is determined by at least one of a driver's input or by a global positioning system.

18. The computer program product of claim 14, wherein the function is at least one of raising a convertible top, lowering the convertible top, raising a window, lowering the window, honking a horn, flashing headlights, unlocking a door, locking the door, raising a sunshade, and lowering the sunshade.

19. The computer program product of claim 14, wherein the condition is from a timer that specifies when the function should occur and further includes:
computer usable program code for receiving the condition that a time has been met that the specific function should be initiated; and
computer usable program code for sending the command to the device actuator to automatically perform the specific function within the set of vehicle functions in response to receiving the indication.

20. The computer program product of claim 14, wherein the sensor is a wireless device sensor that indicates a function to be performed and further includes:
computer usable program code for receiving the signal from the wireless device to perform a specific function;
computer usable program code for sending the command to the device actuator to automatically perform the specific function within the set of vehicle functions in response to receiving the signal.
